(19) United States
(12) Patent Application Publication
(10) Pub. No.: US 2009/0311568 A1
(43) Pub. Date: Dec. 17, 2009

(54) CATALYST LAYER, MEMBRANE ELECTRODE ASSEMBLY, FUEL CELL, AND METHOD FOR MANUFACTURING CATALYST LAYER

(75) Inventor: Kazuhiro Yamada, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/484,106

(22) Filed: Jun. 12, 2009

(30) Foreign Application Priority Data
Jun. 17, 2008 (JP) 2008-157986

(51) Int. Cl. H01M 4/00; B32B 37/00

(52) U.S. Cl. 429/27; 156/60

(57) ABSTRACT

A catalyst layer that has good long-term water resistance and in which outflow of the hydrophobizing agent present on the catalyst layer surface is prevented, a membrane electrode assembly, a fuel cell, and a method for manufacturing a catalyst layer. The first aspect of the present invention relates to a catalyst layer having a catalyst structural body including platinum and gold, a proton conductive electrolyte, and a siloxane polymer having a hydrophobic group and a group including —SH, wherein a sulfur atom of the group including —SH of the siloxane polymer and the gold of the catalyst structural body are bound by a thiol bond.

### BACKGROUND OF THE INVENTION

1. Field of the Invention

The present invention relates to a catalyst layer, a membrane electrode assembly, a fuel cell, and a method for manufacturing a catalyst layer.

2. Description of the Related Art

Japanese Patent Laid-Open No. 2006-332041 describes a method by which a Si compound having a hydrophobic substituent that generates a polymerizable group in a hydrolysis reaction induced by a catalytic action of platinum oxide is brought into contact with a structural body composed of porous platinum oxide and the platinum oxide is thereafter reduced. A hydrophobizing agent including methylsiloxane or the like can thus be easily added to a catalyst layer.

However, long-term water resistance of the porous catalyst layer described in Japanese Patent Laid-Open No. 2006-332041 is hardly sufficient and further improvement is desired.

### SUMMARY OF THE INVENTION

Accordingly, the present invention provides a catalyst layer that has good long-term water resistance and in which outflow of the hydrophobizing agent present on the catalyst layer surface is prevented, a membrane electrode assembly, a fuel cell, and a method for manufacturing a catalyst layer.

The first aspect of the present invention relates to

a catalyst layer having:

a catalyst structural body including platinum and gold, a proton conductive electrolyte, and a siloxane polymer having a hydrophobic group and a group including —SH, wherein

a sulfur atom of the group including —SH of the siloxane polymer and the gold of the catalyst structural body are bound by a thiol bond.

The second aspect of the present invention relates to a membrane electrode assembly including the catalyst layer according to the first aspect of the present invention and a polymer electrolyte membrane.

The third aspect of the present invention relates to a fuel cell including the membrane electrode assembly according to the second aspect of the present invention, a gas diffusion layer, and a current collector.

The fourth aspect of the present invention relates to:

a method for manufacturing a catalyst layer, including the processes of:

(1) attaching a Si compound (a) including Si, —OH bound to the Si or a group that is bound to the Si and becomes —OH upon hydrolysis, and a hydrophobic group to a surface of a catalyst precursor including platinum oxide and gold oxide or gold;

(2) reducing the catalyst precursor to which the Si compound (a) has been attached to obtain a catalyst structural body (A);

(3) attaching a Si compound (b) including Si, —OH bound to the Si or a group that is bound to the Si and becomes —OH upon hydrolysis, and a group including —SH to a surface of the catalyst structural body (A); and

(4) attaching a proton conductive electrolyte to a surface of the catalyst structural body (A) to which the Si compound (b) has been attached.

The fifth aspect of the present invention relates to:

a method for manufacturing a catalyst layer, including the processes of:

(i) forming a siloxane polymer including a hydrophobic group and a group including —SH on a surface of a catalyst precursor including platinum oxide and gold oxide or gold;

(ii) reducing the catalyst precursor on which the siloxane polymer has been attached to obtain a catalyst structural body (B); and

(iii) attaching a proton conductive electrolyte to a surface of the catalyst structural body (B).

The sixth aspect of the present invention relates to:

a method for manufacturing a catalyst layer, including the processes of:

(I) forming a siloxane polymer including a hydrophobic group and a group including —SH on a surface of a catalyst precursor including platinum oxide and gold oxide or gold;

(II) attaching a proton conductive electrolyte to the surface of the catalyst precursor on which the siloxane polymer has been formed; and

(III) reducing the catalyst precursor to which the proton conductive electrolyte has been attached.

Further features of the present invention will become apparent from the following description of exemplary embodiments with reference to the attached drawings.

### BRIEF DESCRIPTION OF THE DRAWINGS

FIG. 1 shows an example of the catalyst layer in accordance with the present invention;

FIG. 2 is a schematic cross-sectional view illustrating an example of the membrane electrode assembly in accordance with the present invention;

FIG. 3 is a schematic diagram illustrating an example of a cross-sectional configuration of a unit cell of a solid polymer fuel cell;

FIG. 4 is a flowchart illustrating the fourth process in accordance with the present invention;

FIG. 5 is a flowchart illustrating the fifth process in accordance with the present invention;

FIG. 6 is a flowchart illustrating the sixth process in accordance with the present invention;

FIG. 7 is a schematic diagram illustrating an evaluation device for solid polymer fuel cells of the present example and a comparative example;

FIG. 8 illustrates a voltage-current density characteristic of fuel cell units of Example 1 and Comparative Example 1;

FIG. 9 shows how a current density of fuel cell units of Example 7 and Comparative Example 2 changes with time.

### DESCRIPTION OF THE EMBODIMENT

An example of preferred embodiment of the present invention will be described below. However, the scope of the present invention is determined by the claims, and the description below places no limitation on the scope of the present invention. For example, the materials, dimensions, shapes, arrangements, and manufacturing conditions described hereinbelow place no limitation on the scope of the invention.

The first aspect of the present invention relates to:

a catalyst layer having:

a catalyst structural body including platinum and gold, a proton conductive electrolyte, and a siloxane polymer having a hydrophobic group and a group including —SH, wherein

a sulfur atom of the group containing —SH of the siloxane polymer and the gold of the catalyst structural body are bound by a thiol bond.

The presence of a bond of sulfur and gold (that is, Au—S thiolate bond) can be measured from a S2p_{(3/2)} peak position of binding energy of the sulfur atom by XPS measurements. For an S atom in a sulfonate group in an electrolyte, the peak position is close to 167.2 eV, but for a thiolate-bound S atom, the peak position is known to be 162.0 eV.

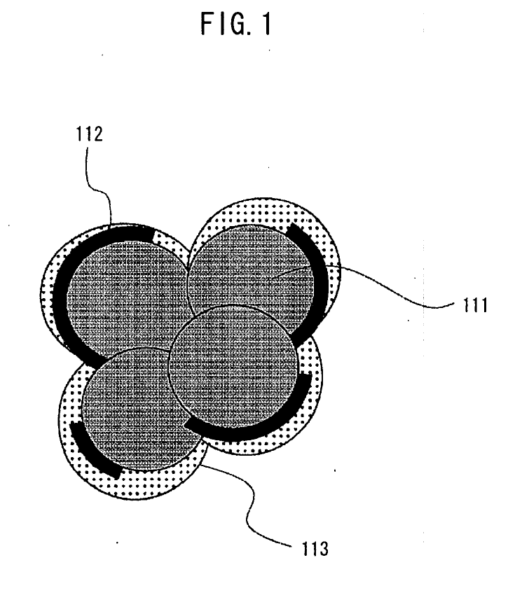

FIG. 1 represents schematically a taken-out part of the first catalyst layer in accordance with the present invention.

In FIG. 1, the reference numeral 111 stands for a catalyst structural body including platinum and gold, 112—a siloxane polymer, and 113—a proton conductive electrolyte.

These components will be described below.

The catalyst structural body 111 is a catalyst structural body including platinum and gold. Because gold is included in the catalyst structural body 111, the gold and a sulfur atom of a group including —SH (thiol group) of the siloxane polymer 112 that has the below-described hydrophobic group are bound by the thiol group, and the siloxane polymer having the hydrophobic group is strongly fixed to the surface of the catalyst structural body 111. In addition to gold and platinum, the catalyst structural body 111 may also include transition metal elements such as cobalt, copper, and iron, noble metal elements such as ruthenium and iridium, titanium oxide, and niobium oxide. The amount of gold contained in the catalyst structural body 111 may be such as to enable the inhibition of outflow of the siloxane polymer 112 having a hydrophobic group, but the amount of gold and platinum contained in the catalyst structural body (total amount of gold and platinum) is preferably within a range of 0.1 at. % to 6.4 at. % (in other words, the ratio of Au/(Pt+Au) in the catalyst structural body 111 is preferably 0.1 at. % to 6.4 at. %). A range of 0.5 at. % to 6.0 at. % is more preferred, and a range of 1.0 at. % to 6.0 at. % is even more preferred. This is because when the amount of gold contained in the catalyst structural body is within the aforementioned ranges with respect to the amount of platinum contained in the catalyst structural body, the gold is present in an amount sufficient to enable binding of the sulfur atom of —SH of the group including —SH in the siloxane polymer having a hydrophobic group. Furthermore, densification that can sometimes occur in the catalyst layer when gold is present in a large amount and the decrease in gas diffusion ability caused by the densification can hardly occur.

In FIG. 1, the catalyst structural body 111 is represented by a sphere, but it may be of other shapes (for example, in a shape of a wire, a disk, a flat plate, or a rugby ball). Among these shapes, a dendritic shape of the catalyst structural body 111 in which an assembly of fine catalyst particles is formed is preferred. This is because, the dendritic shape ensures an increased specific surface area. The “dendritic shape” as referred to herein means a structure in which a large number of flaky structures configured by an assembly of fine catalyst particles with a diameter equal to or less than 10 nm are collected in branching points. One flake structure preferably has a length in the short side direction thereof of equal to or greater than 5 nm and equal to or less than 200 nm. The length in the short side direction as referred to herein means a minimum dimension in the plane of one flake.

The siloxane polymer 112 having a hydrophobic group and a group including —SH has a main chain composed of a siloxane skeleton in which Si and O are alternately bound, a hydrophobic group, and a group including —SH.

Because the siloxane polymer 112 has a hydrophobic group, the catalyst layer is hydrophobic and water resistance is increased. “Hydrophobic” in accordance with the present invention and as referred to in the present description relates to a case where a contact angle with water is equal to or greater than 90°. Examples of such hydrophobic group include alkyl groups (straight-chain alkyl groups or a phenyl group) and fluoroalkyl groups. The hydrophobic group is preferably present in a side chain of the siloxane polymer.

The group including —SH is preferably also present in the side chain of the siloxane polymer 112, but may be also present at the end of the main chain. The preferred examples of the group including —SH include alkylthiols, alkylenethiols, and alkanethiols having 2 to 8 carbon atoms. More specific examples include propylthiol, butylthiol, octylthiol, laurylthiol, ethylenedithiol, propylenedithiol, 1,3-butylenedithiol, 1,4-butanedithiol, 1,6-hexanedithiol, and 3-methylpentanedithiol.

Specific examples of the siloxane polymer having a hydrophobic group and a group including —SH include mercapto-modified alkyl polysiloxanes and mercapto-modified alkylene polysiloxanes. A functional group equivalent of the group including —SH may be within a range in which the outflow of the hydrophobizing agent 12 can be inhibited. The preferred range is 1600 to 30,000. Within this range, a sufficient water repellency can be maintained. The functional group equivalent of an A group, as referred to herein, is a weight of a molecule including the A group that is necessary to obtain 1 mol of the A group.

The degree of polymerization (siloxane units) of the siloxane polymer including a hydrophobic group and a group including —SH is not particularly limited, provided that uniform dispersion within the pores of the catalyst layer is possible, but a range of 10 to 100 is preferred. Where the degree of polymerization is within this range, an oily system with a low viscosity is obtained and uniform dispersion can be easily produced.

The amount of the siloxane polymer is preferably adjusted so that the ratio Si/(Pt+Au) of the number of atoms of silicon, platinum and gold in the catalyst layer is within a range of 0.1 at. % to 0.32 at. %. Where this ratio is equal to or less than 0.1 at. %, sufficient water repellency is not obtained, and where the ratio is equal to or greater than 0.32 at. %, the surface of Pt atoms is excessively covered with the siloxane polymer. As a result, the number of reaction sites in the catalyst decreases and power generation capacity is decreased.

The proton conductive electrolyte 113 is composed of a polymer compound having a proton conductive group. Examples of the polymer compound having a proton conductive group include perfluorocarbon polymers having a sulfonate group, such as NAFION™ (Du Pont Co.). Other examples include sulfonated aromatic polyether ketones and polysulfones. Compounds obtained by modifying a phosphate group in pores of zeolites or mesoporous silica, such as described in Japanese Patent Laid-Open Nos. 2007-200601 and 2006-134849, can be also used.

The second aspect of the present invention will be described below.

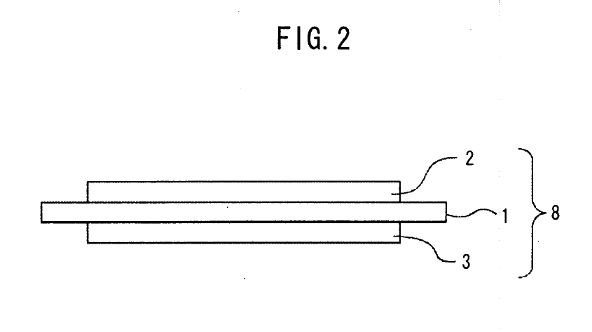

FIG. 2 shows a membrane electrode assembly 8 of the second aspect of the present invention. In the figure, the reference numeral 1 stands for a polymer electrolyte membrane (sometimes referred to hereinbelow simply as “electrolyte membrane”), 2—an anoode catalyst layer, and 3—a cathode catalyst layer.

At least one layer from among the anoode catalyst layer 2 and cathode catalyst layer 3 is the catalyst layer according to the first aspect of the present invention. Therefore, at least one layer from among the anoode catalyst layer and cathode catalyst layer may be the catalyst layer according to the first aspect of the present invention or both layers may be the catalyst layer according to the first aspect of the present invention. Furthermore, because flooding can easily occur in the cathode catalyst layer where water is generated and the generated water can be easily accumulated therein, it is preferred that at least the cathode catalyst layer be the catalyst layer according to the first aspect of the present invention.

The polymer electrolyte membrane 1 is a polymer electrolyte membrane that has proton conductivity and has a function of transmitting the protons (H⁺) generated at the anode side to the cathode side. Examples of the polymer electrolyte membrane include perfluorocarbon polymers having a sulfonate group, such as NAFION™ (Du Pont Co.), sulfonated aromatic polyether ketones, and polysulfones. Proton conductive polymer composite membranes in which a proton conductive electrolyte having a phosphate group is dispersed in fine pores of zeolites or mesoporous silica in an organic polymer can be also used.

In a case where the membrane electrode assembly according to the second aspect of the present invention has a catalyst layer other than the catalyst layer according to the first aspect of the present invention (that is, in a case where only one from among the cathode catalyst layer and anoode catalyst layer is the catalyst layer according to the first aspect of the present invention), the catalyst layer other than the catalyst layer according to the first aspect of the present invention can be configured by a structure composed of a platinum structural body and platinum-supporting carbon.

When the membrane electrode assembly according to the second aspect of the present invention is formed, it is preferred that hot pressing be performed at a temperature of 130° C. to 150° C., a pressurization time of 1 min to 30 min, and a pressure of 1 MPa to 40 MPa. In a case where a catalyst precursor is formed on a transfer substrate, the transfer substrate is peeled off after the hot pressing.

The third aspect of the present invention will be described below.

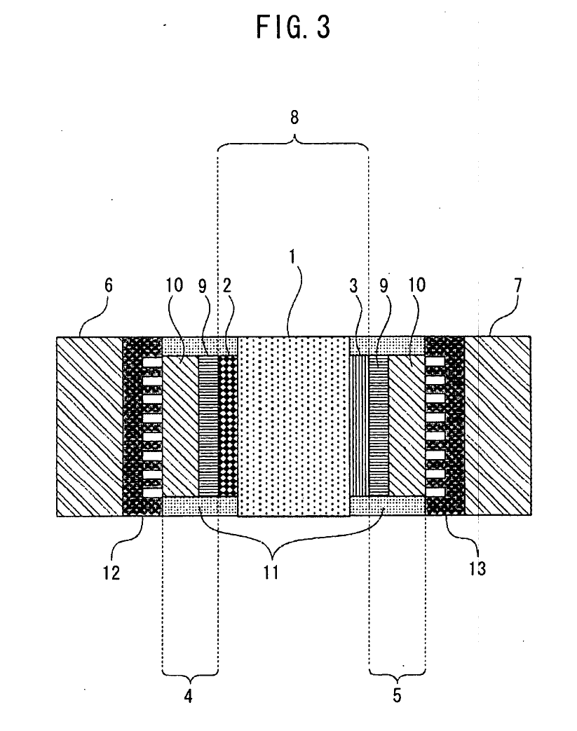

FIG. 3 shows a cross-section of an exemplary fuel cell according to the third aspect of the present invention. In the figure, the reference numeral 8 stands for a membrane electrode assembly according to the second aspect of the present invention, 4—an anode-side gas diffusion layer, 5—a cathode-side gas diffusion layer, 6—an anode-side collector, 7—a cathode-side collector, 12—an anode-side separator, and 13—a cathode-side separator.

The anode-side gas diffusion layer 4 and the cathode-side gas diffusion layer 5 serve to supply oxygen or fuel to the membrane electrode assembly 8. The anode-side gas diffusion layer 4 and the cathode-side gas diffusion layer 5 are preferably configured by a plurality of sub-layers. Where they are configured by a plurality of sub-layers, it is preferred that those sub-layers of the anode-side gas diffusion layer 4 and the cathode-side gas diffusion layer 5 that are in contact with the membrane electrode assembly 8 have an average size of pores less than other sub-layers. More specifically, in a case where the gas diffusion layers are configured by two sub-layers, as shown in FIG. 3, it is preferred that an average diameter of pores in a sub-layers 9, which come into contact with the membrane electrode assembly 8, from among the sub-layers of the anode-side gas diffusion layer 4 and the cathode-side gas diffusion layer 5, be less than an average diameter of pores in other sub-layers 10 constituting the anode-side gas diffusion layer 4 and the cathode-side gas diffusion layer 5.

In a case where those sub-layers of the anode-side gas diffusion layer 4 and the cathode-side gas diffusion layer 5 that are in contact with the membrane electrode assembly 8 have an average size of pores less than other sub-layers, these sub-layers that are in contact with the membrane electrode assembly 8 will be hereinbelow sometimes called microporous layers (MPL).

For example, a layer comprising carbon microparticles and using PTFE as a binder can be used as the MPL. Examples of the carbon microparticles include acetylene black, Ketjen black, fibrous carbon formed by vapor-phase growth, and carbon nanotubes.

A carbon cloth, carbon paper, and porous metals can be used for portions other than the MPL among the sub-layers constituting the gas diffusion layers 4 and 5, and a gas diffusion layer of a three-layer structure can be obtained by laminating the aforementioned layers and combining with MPL. In a case where a metal material is used, a material with excellent oxidation resistance has to be used. Specific examples of preferred materials include SUS 316L, nickel-chromium alloys, and titanium. For example, CELMET™ (manufactured by Toyama Sumitomo Denko KK) can be used as the porous nickel chromium alloy.

Materials with excellent conductivity and oxidation resistance can be used for the anode-side collector, cathode-side collector 7, anode-side separator, and cathode-side separator. Examples of such materials include platinum, titanium, carbon, stainless steel (SUS), SUS coated with gold, SUS coated with carbon, aluminum coated with gold, and aluminum coated with carbon.

In a typical configuration, channels (white portions present in the anode-side separator 12 and cathode-side separator 13 in FIG. 3) are provided in the separators. Furthermore, gas supply ports (not shown in FIG. 3) linked to the channels are provided on the surfaces of the anode-side separator 12 and cathode-side separator 13 that are on the MEA side (in other words, the surface on the side that is not in contact with the anode-side collector 6 and cathode-side collector 7). When the fuel cell is caused to generate energy, a fuel gas or an oxidizing agent gas is supplied from the gas supply port to the gas diffusion layer. The flow channels of the separators also serve to discharge water generated in the power generation process. Here, a configuration is shown in which the anode-side separator 12 and cathode-side separator 13 are present, but these separators may be integrated with the collectors.

A fuel cell of a single cell structure is explained herein as an example according to the third aspect of the present invention, but the fuel cell according to the third aspect of the present invention may have a structure in which a plurality of the above-described fuel cells are stacked.

The fourth aspect of the present invention will be described below.

The fourth aspect of the present invention relates to a method for manufacturing a catalyst layer, including the processes of:

(1) attaching a Si compound (a) including Si, —OH bound to the Si or a group that is bound to the Si and becomes —OH upon hydrolysis, and a hydrophobic group to a surface of a catalyst precursor including platinum oxide and gold oxide or gold;

(2) reducing the catalyst precursor to which the Si compound has been attached to obtain a catalyst structural body (A);

(3) attaching a Si compound (b) including Si, —OH bound to the Si or a group that is bound to the Si and becomes —OH upon hydrolysis, and a group including —SH to a surface of the catalyst structural body (A); and

(4) attaching a proton conductive electrolyte to a surface of the catalyst structural body (A).

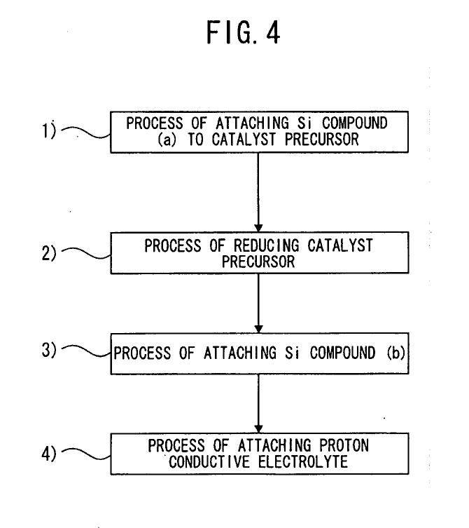

A flowchart of the manufacturing method according to the fourth aspect of the present invention is shown in FIG. 4.

The process (1) will be described below.

In the process (1), a Si compound including Si, —OH bound to the Si or a group that is bound to the Si and becomes —OH upon hydrolysis, and a hydrophobic group is attached to a surface of a catalyst precursor including platinum oxide and gold oxide or gold. The catalyst precursor including platinum oxide and gold oxide or gold is preferably a porous body. It is even more preferred that the catalyst precursor have a dendritic shape. The definition of the dendritic shape is identical to that of the dendritic shape in the catalyst layer according to the first aspect of the present invention.

The catalyst precursor can be represented as being composed of PtOₓ and AuOₓ or by PtOₓ and Au. In this case, X may be equal to or more than 2, but in a case where the catalyst precursor has a dendritic shape, X is preferably within a range of equal to greater than 2 and equal to or less than 2.5. Furthermore, in a case where the catalyst precursor has a dendritic shape, the Au/(Pt+Au) in the catalyst precursor is preferably 0.1 at. % to 6.4 at. %. The amount of gold is set within the aforementioned range with respect to the amount of platinum and gold because gold is then present in an amount sufficient to enable binding of the sulfur atom of the group including —SH in the Si compound (b) to be attached in the process (3), and decrease in gas diffusion ability caused by densification of the catalyst layer can hardly occur.

In a case where a catalyst precursor including platinum oxide and gold oxide or gold is formed, it is preferred that a sputtering method such as reactive sputtering or a reactive vapor-phase method such as a reactive ion plating method be used. In this case, the film formation conditions (film formation pressure, RF power applied to the target, and oxygen partial pressure during film formation) are appropriately adjusted so as to obtain an O/Pt ratio satisfying the above-described condition.

The catalyst precursor layer formed on a substrate may be then transferred to the polymer electrolyte membrane surface, or may be formed on a gas diffusion layer and then the gas diffusion layer and the catalyst precursor layer may be joined to the surface of the polymer electrolyte membrane surface. Also, the catalyst precursor layer may be directly formed on the surface of the polymer electrolyte membrane

Where the catalyst precursor layer is formed on a substrate and then transferred to the polymer electrolyte membrane surface, the transfer process is preferably carried out after the below-described process (4). In a case where the catalyst precursor layer is transferred or joined to the polymer electrolyte membrane surface before the process (4), because the proton conductive electrolyte that will be added in the process (4) is not contained in the catalyst precursor layer, sufficient adhesion of the polymer electrolyte membrane and the catalyst precursor layer sometimes cannot be obtained.

In a case where the catalyst precursor layer is transferred on the polymer electrolyte membrane surface after being formed on the substrate, it is preferred that a material with a heat resistance of equal to or higher than 130° C. be used for the substrate. This is because where a substrate made from a material with a heat resistance of equal to or higher than 130° C. is used, when hot pressing is carried out after the transfer, the hot pressing can be carried out at a temperature equal to or higher than a glass transition temperature (130° C. in NAFION™). Furthermore, where a material with high heat resistance is used, damage to the substrate during vapor-phase film growth can be easily prevented.

For example, a resin sheet with high heat resistance such as PTFE, a polycarbonate, and a polyimide can be used as such a material. When a polycarbonate or polyimide is used, the sheet preferably has a multilayer structure and a parting layer composed of a fluororesin or a fluorosilane is preferably formed on the film formation surface of the catalyst layer.

In a case where the gas diffusion layer having the catalyst precursor layer formed thereon is joined to the polymer electrolyte membrane surface, it is also preferred that the joining process be carried out after the below-described process (4).

Where the gas diffusion layer having the catalyst precursor layer formed thereon is joined to the polymer electrolyte membrane surface, a carbon support such as carbon particles and carbon fibers or a resin sheet having the carbon support present in the form of a layer on the surface thereof may be used as the gas diffusion layer. The carbon support may be also present in the form of a layer on the surface of carbon cloth or carbon paper.

In a case where the catalyst precursor layer is formed on the polymer electrolyte membrane surface, the aforementioned process of transferring or joining the catalyst precursor layer polymer electrolyte membrane surface is unnecessary.

The Si compound (a) has Si, —OH bound to the Si or a group that is bound to the Si and becomes —OH upon hydrolysis, and a hydrophobic group.

—OH in a case where the Si compound (a) has Si—OH (in other words, has —OH bound to Si) or —OH of the formed Si—OH is polymerized by dehydration condensation reaction occurring between the —OH groups, and a siloxane polymer (sometimes referred to hereinbelow as ‘hydrophobizing agent” or siloxane polymer (β)) having a siloxane skeleton in which the hydrophobic group, Si, and O are alternately bound on the catalyst precursor surface is formed.

Where the Si compound (a) has a group that is bound to Si and becomes —OH upon hydrolysis, the group that is bound to Si and becomes —OH upon hydrolysis is hydrolyzed and becomes —OH in a process in which an acid contained in the proton conductive electrolyte, platinum oxide of the catalyst precursor layer, or Pt contained in the platinum oxide serves as a catalyst.

Examples of the group that is bound to Si and becomes —OH upon hydrolysis include —H, —OR (R: an alkyl group having 6 or fewer atoms), and —Cl.

Examples of the hydrophobic group include an alkyl group and a fluoroalkyl group. The alkyl group in this case may have a branched carbon chain or may have a double bond.

Such a Si compound (a) may be a monomer, an oligomer, or a polymer, provided that it has Si, —OH bound to the Si or a group that is bound to the Si and becomes —OH upon hydrolysis, and a hydrophobic group. Therefore, it may be a siloxane polymer having or alkylsilane having the above-described groups. Specific examples of the Si compound include 2,4,6,8-tetraalkylcyclotetrasiloxane, 1,1,1,3,3,3-hexaalkyldisilazane, monoalkylsilane, dialkylsilane, trialkylsilane, polyalkylhydrodienesiloxane, 2,4,6,8-tetraalkyltetraalkoxycyclotetrasiloxane, monoalkyltrialkoxysilane, dialkyldialkoxysilane, trialkylmonoalkoxysilane, polyalkylalkoxysiloxane, 2,4,6,8-tetraalkyltetrachlorocyclotetrasiloxane, monoalkyltrichlorosilane, dialkyldichlorosilane, trialkylmonochlorosilane, and polyalkylchlorosiloxane. The alkyl group in these compounds may be a fluoroalkyl group obtained by substituting some or all H atoms with F atoms.

The Si compound (a) can be attached to the surface of the catalyst precursor layer by a well-known method, for example, a method by which the catalyst precursor layer is immersed in a solution of the Si compound (a), a method by which the solution is coated on the catalyst precursor layer by dropping, brush coating, spraying, or the like, a method using spraying, spin coating, or dip coating, and a CVD method (Japanese Patent Laid-Open No. 2006-332041, Tokuhyo 1999-510643, Japanese Patent Laid-Open No. 2006-164575).

Furthermore, it is preferred that the Si compound (a) that has Si, —OH bound to the Si or a group that is bound to the Si and becomes —OH upon hydrolysis, and a hydrophobic group be attached in an amount such that a Si/Pt molar ratio becomes 0.1-0.25.

This is because where the amount attached is too small, hydrophobicity inside the pores of the catalyst layer decreases and the catalyst layer can be easily flooded, and where the amount attached is too large, the reaction surface area of the catalyst becomes small and the catalyst utilization efficiency decreases.

In a case where CVD is carried out at room temperature by setting a Si/Pt molar ratio to 0.1 to 0.25 and using 2,4,6,8-tetramethylcyclotetrasiloxane as a starting material gas, as described in Japanese Patent Laid-Open No. 2006-332041, it is preferred that a contact time of the catalyst precursor layer composed of platinum oxide and the starting material gas be 3 to 5 min.

In a case where a method based on coating is used, it is preferred that a solvent in which a hydrophobizing agent is dissolved have high mutual solubility with the hydrophobizing agent, and a lower alcohol such as IPA can be used.

The process (2) will be described below.

In the process (2), a catalyst structure (A) is formed by reducing the catalyst precursor that has been obtained in the process (1) and has attached thereto the Si compound (a). More specifically, platinum oxide present in the catalyst precursor is reduced to platinum, and in a case where gold oxide is contained in the catalyst precursor, the gold oxide is reduced to gold.

Reduction with hydrogen gas, reduction with a solution, or electrochemical reduction may be used for reducing the catalyst precursor.

The process (3) will be described below.

In the process (3), a Si compound (b) having Si, —OH bound to the Si or a group that is bound to the Si and becomes —OH upon hydrolysis, and a group including —SH is attached to a surface of the catalyst structural body (A) obtained in the process (2).

—OH or —OH of the Si—OH formed by hydrolysis that is contained in the Si compound (b) is polymerized by a dehydration condensation reaction occurring between the —OH groups, and a siloxane polymer (sometimes referred to hereinbelow as siloxane polymer (γ)) having a siloxane skeleton that has a —SH group and in which Si and O are alternately bound is formed.

The —OH of the hydrophobizing agent obtained in the process (1) and the —OH of the siloxane polymer (γ) are bound by a dehydration condensation reaction occurring between the —OH groups, and a siloxane polymer (α) is formed.

Further, a sulfur atom of the group including a —SH group of the Si compound (b) is bound by a thiol bond to the Au atom of the catalyst structural body (A). Thus, the siloxane polymer (α) is bound to the catalyst structural body (A) by a thiol bond. Therefore, the hydrophobizing agent constituting the siloxane polymer (α) is strongly fixed to the catalyst structural body (A).

Examples of the group that is bound to Si and becomes —OH upon hydrolysis include —H, —OR (R: an alkyl group having 1 to 6 carbon atoms), and —Cl.

Examples of such silane compound include 3-mercaptopropyltrimethoxysilane, 3-mercaptopropylmethyldimethoxysilane, 3-mercaptopropyltriethoxysilane, 3-mercaptopropylmethyldiethoxysilane, and polycondensates thereof.

The process (4) will be described below.

In the process (4), a proton conductive electrolyte is attached to a surface of the catalyst structural body (A) to which the Si compound (b) obtained in the process (3) has been attached.

The proton conductive electrolyte is a polymer compound having a proton conductive group. Examples of the polymer compound having a proton conductive group include perfluorocarbon polymers having a sulfonate group, such as NAFION™ (Du Pont Co.). Other examples include sulfonated aromatic polyether ketones and polysulfones. Compounds having a phosphate group in pores of zeolites or mesoporous silica can be also used.

The proton conductive electrolyte can be attached, for example, by a method of dropping a proton conductive electrolyte solution prepared by dissolving the proton conductive electrolyte in a solvent on a catalyst layer and then blow drying. In this case, the concentration and dropping amount of the proton conductive electrolyte solution are preferably adjusted so that the proton conductive electrolyte takes 6 wt. % to 8 wt. % based on Pt.

The fifth aspect of the present invention will be described below.

The fifth aspect of the present invention relates to a method for manufacturing a catalyst layer, comprising the processes of:

(i) forming a siloxane polymer comprising a hydrophobic group and a group including —SH on a surface of a catalyst precursor comprising platinum oxide and gold oxide or gold;

(ii) reducing the catalyst precursor on which the siloxane polymer has been attached to obtain a catalyst structural body (B); and

(iii) attaching a proton conductive electrolyte to a surface of the catalyst structural body (B).

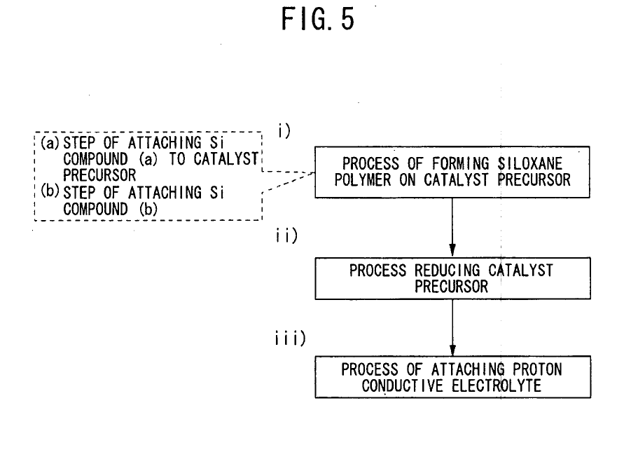

A flowchart according to the fifth aspect of the present invention is shown in FIG. 5.

The process (i) will be described below.

In the process (i), a siloxane polymer (δ) having a hydrophobic group and a group including —SH is formed on a surface of a catalyst precursor including platinum oxide and gold oxide or gold.

The catalyst precursor in the present process is similar to the catalyst precursor according to the fourth aspect of the present invention.

The process of forming a siloxane polymer having a hydrophobic group and a group including —SH on the catalyst precursor surface may be performed in one step of attaching a siloxane polymer (δ) having a hydrophobic group and a group including —SH, or in two steps. When the process is implemented in one step, in the siloxane polymer (δ), the group including —SH is preferably an end group of the main chain of the siloxane polymer (δ). A mercapto-modified silicone oil can be used as such a siloxane polymer (δ). In a case where the process is implemented in two steps, the process has a step of attaching the Si compound (a) that has been attached in the process (1) of the fourth aspect of the present invention to a catalyst precursor surface and a step of attaching the Si compound (b) that has been attached in the process (3) of the fourth aspect of the present invention to the catalyst precursor to which the Si compound (a) has been attached. As a result, the siloxane polymer (δ) having a hydrophobic group and a group including —SH is formed on the catalyst precursor surface. In most cases the siloxane polymer (δ) of the case in which the process is implemented in two steps and the siloxane polymer (α) according to the fourth aspect of the present invention are identical.

The process (ii) will be described below.

In the process (ii), a catalyst structural body (B) is formed by performing reduction of the catalyst precursor on which the siloxane polymer (δ) obtained in the process (i) has been formed.

As a result, the sulfur atom of the group including —SH of the siloxane polymer (δ) obtained in the process (i) is bound to gold of the catalyst structural body (B). Furthermore, in a case where the catalyst precursor has gold, a sulfur atom of the group including —SH of the siloxane polymer (δ) is bound to gold prior to the process (ii), but in a case where the catalyst precursor has gold oxide, the sulfur atom of the group including —SH is bound to the gold atom by converting the gold oxide into gold by the process (ii).

The process (iii) will be described below.

In the process (iii), a proton conductive electrolyte is attached to the surface of the catalyst structural body (B). A method for attaching the proton conductive electrolyte to the surface of the catalyst structural body (B) is similar to the process (4) of the fourth aspect of the present invention.

The sixth aspect of the present invention will be described below.

The sixth aspect of the present invention relates to a method for manufacturing a catalyst layer, comprising the processes of:

(I) forming a siloxane polymer including a hydrophobic group and a group including —SH on a surface of a catalyst precursor comprising platinum oxide and gold oxide or gold;

(II) attaching a proton conductive electrolyte to the surface of the catalyst precursor on which the siloxane polymer has been formed; and

(III) reducing the catalyst precursor to which the proton conductive electrolyte has been attached.

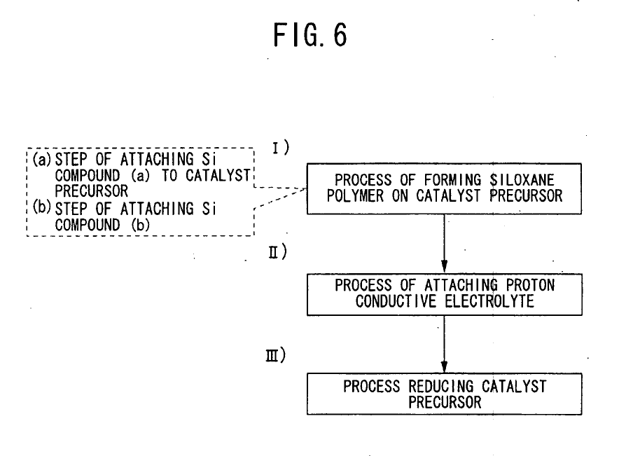

The flowchart according to the sixth aspect of the present invention is shown in FIG. 6.

The sixth aspect of the present invention is similar to the fifth aspect of the present invention, except that the process (ii) and the process (iii) of the fifth aspect of the present invention changed places. According to the sixth aspect of the present invention, the catalyst precursor is reduced after the proton conductive electrolyte has been attached to the catalyst precursor. Therefore, the shape of the catalyst precursor can be easily maintained.

### EXAMPLES

The present invention will be described below in greater details with reference to specific examples.

### Example 1

FIG. 3 shows a solid polymer fuel cell used in the present example.

### (Process 1)

First, as a catalyst precursor layer formation process, a PtAuOx layer was deposited to a thickness of 2 μm by a RF reactive sputtering method using Pt (4N) and Au (4N) targets on the surface of a PTFE sheet (NITOFLON™, manufactured by Nitto Denko Corp.; can be referred to hereinbelow as “substrate”). CS-200 by ULVAC Corp. was used as the reactive sputtering apparatus. In this case, the reactive sputtering was carried out under a total pressure of 5 Pa, 100% oxygen gas, and a substrate heater temperature of 40° C. The RF power of each target was adjusted to obtain Au at 1 at. % based on Pt+Au. More specifically, the sputtering was carried out under the following conditions: the RF (high frequency of 13.56 MHz) power supplied to the Pt target was 5.4 W/cm² and the RF power supplied to the Au target was 0.27 W/cm².

### (Process 2)

A hydrophobizing agent was formed on the PtAuOx surface according to the well-known technology described in Japanese Patent Laid-Open No. 2006-332041. Thus, The catalyst precursor layer obtained in Process 1 was treated for 4 min with vapors of 2,4,6,8-tetramethyltetracyclosiloxane at room temperature (vapor pressure about 1.2 kPa) in a sealed container to form an appropriate amount of the hydrophobizing agent on the PtAuOx surface. A Si/Pt molar ratio in the catalyst precursor was 0.24.

### (Process 3)

A reduction treatment was then performed by exposing the obtained PtAuOx layer to a 2% H₂/He atmosphere for 30 min, and a porous PtAu catalyst layer having a dendritic shape was obtained on the PTFE sheet surface. The supported amount of Pt was 0.6 mg/cm².

### (Process 4)

The obtained PtAu catalyst layer was treated for 10 min with vapors of mercaptopropyltrimethoxysilane (abbreviated hereinbelow as MPTMS) at room temperature (vapor pressure about 665 Pa) in a sealed container and Au contained in the PtAu and the hydrophobizing agent were bound. A SH group: Au molar ratio was 2.4.

### (Process 5)

A 1 wt. % NAFION solution (a solution obtained by diluting a 5 wt. % NAFION-dispersed solution produced by SIGMA Aldrich Co. with IPA to 1 wt. %) was dropped on the obtained catalyst layer at a ratio of 8 μl per 1 cm² of the catalyst surface area and the solvent was evaporated under vacuum to form an interface with an electrolyte on the catalyst surface.

### (Process 6)

In order to produce an anoode catalyst layer, a platinum-supporting carbon layer was formed on the PTFE sheet surface by a doctor blade method to obtain the supported amount of Pt of 0.3 mg/cm². The catalyst slurry attached to the PTFE sheet surface in this case was obtained by kneading 1 part by weight of platinum-supporting carbon (HiSPEC 4000, produced by Johnson Matthey Co.), 0.07 part by weight of NAFION, 1 part by weight of IPA, and 0.4 part by weight of water.

### (Process 7)

A solid polymer electrolyte membrane (NAFION 112, produced by Du Pont Co., thickness 50 μm) was sandwiched between the PTFE sheet having the cathode catalyst layer attached thereto (produced in Process 5) and the PTFE sheet having the anoode catalyst layer attached thereto (produced in Process 6) so that the catalyst layers were on the inner side, and hot pressing was carried under the following pressing conditions: 4 MPa, 150° C., and 10 min. The PTFE sheets were then removed by peeling off the PTFE sheets from the anoode catalyst layer and cathode catalyst layer, thereby producing a MEA. Thus, a MEA was obtained in which the cathode catalyst layer was the catalyst layer in accordance with the present invention and the anoode catalyst layer was a platinum-supporting carbon catalyst layer.

### Example 2

A MEA was fabricated in the same manner as in Example 1, except that the RF power supplied to the Au target in Process 1 of Example 1 was 0.54 W/cm², and the Au concentration was 6 at. %. The supported amount of Pt on the cathode catalyst layer was 0.6 mg/cm². The Si/Pt molar ratio was 0.17.

XPS measurements were conducted on the catalyst layer after the Process 5 of Example 2. It was found that the S2p peak position was 162.2 eV and an Au—S thiophene bond was present in the catalyst layer

### Comparative Example 1

A MEA was fabricated in the same manner as in Example 1, except that no Au was added to the catalyst in Process 1 of Example 1. The supported amount of Pt on the cathode catalyst layer was 0.6 mg/cm². The Si/Pt molar ratio was 0.12.

### Evaluation of Examples 1 and 2 and Comparative Example 1

The MEA of Example 1 and Comparative Example 1 were analyzed by X-ray fluorescence analysis (abbreviated hereinbelow as XRF), and the amount of Si that is a constituent element of the hydrophobizing agent was measured. ZSX 1009e (produced by Rigaku KK) was used as the analyzer. Then, the MEA were immersed and held for 4 days in warm water at a temperature of 50° C., followed by drying. The amount of Si was then again measured by XRF. Because the catalyst layers in the MEA had a history of contact with water for a long time, the outflow amount of the hydrophobizing agent could be measured by comparing the amount of Si in the catalyst layer that was measured before and after the warm water immersion test. Because the hydrophobizing agent and MPTMS polymerized and integrated in the MEA, it was necessary to distinguish the hydrophobizing agent and MPTMS in comparing the Si amount before and after the immersion.

The retention ratio of the amount of Si before and after the test in the MEA of Examples 1 and 2 and Comparative Example 1 is shown in Table 1. The retention ratio of the amount of Si was calculated by dividing the amount of Si after the test in each MEA by the amount of Si before the test.

TABLE 1

| | (Number of Au atoms)/ | Si retention |
|---|---|---|
| | (Number of Pt atoms + | ratio after |
| | Number of Au atoms) × | deterioration |
| | 100 (%) | test (wt. %) |
| Comparative | 0 | 33 |
| Example 1 | | |
| Example 1 | 1 | 94 |
| Example 2 | 6 | 81 |

As shown in Table 1, in the MEA of Comparative Example 1, only ⅓ of Si remained after the test, and the outflow of the hydrophobizing agent occurred. By contrast, in the MEA of Examples 1 and 2, a large amount of Si remained and the outflow of the hydrophobizing agent was greatly inhibited.

Fuel cell units were then formed by sandwiching the MEA obtained in Example 1 and Comparative Example 1 between gas diffusion layer 4 (carbon cloth, manufactured by E-TEK Co., LT-2500-W), gas diffusion layer 5 (carbon cloth, manufactured by E-TEK, LT1200-W), anode-side electrode 6, foamed metal 12, and cathode-side electrode 7 in the order shown in FIG. 1. The fuel cell units were also fabricated in the same manner by using the MEA of Example 1 and Comparative Example 1 after the warm water immersion test.

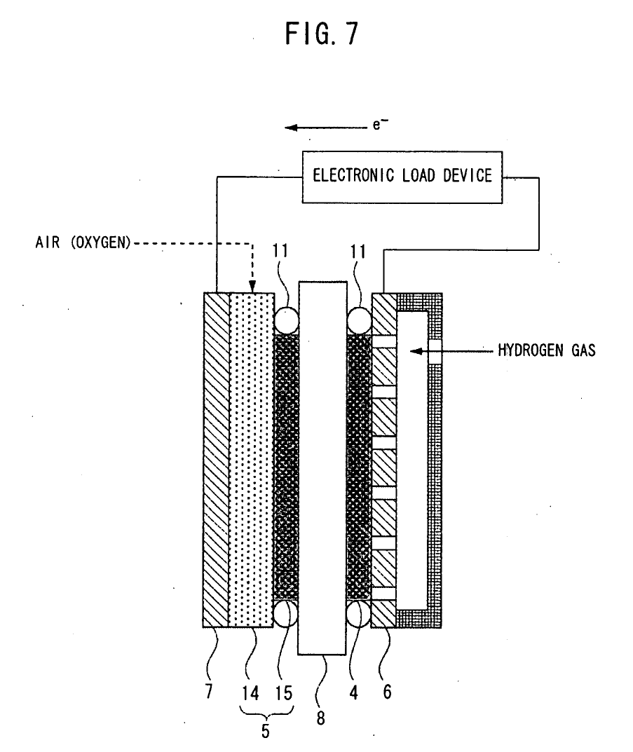

The circumference of the gas diffusion layers 4 and 5 was sealed with an O ring 11. An electronic load device and a hydrogen gas piping were connected, as shown in FIG. 7, to each fuel cell unit, a current sweep test of the fuel cells was carried out, and power generation characteristic was evaluated. As shown in FIG. 7, a slit was provided in the anode-side collector 6 to enable free passage of hydrogen gas. On the anode electrode side, the hydrogen gas was filled at 0.15 MPa at the dead end, and at the cathode electrode side, the fuel cell was open to air. The power generation characteristic was evaluated at a cell temperature of 25° C. and a relative humidity of the ambient environment of 100%. The current sweep rate was 1 mA/cm²/sec. The reference numeral 14 in FIG. 7 stands for a foamed metal, and 15—a carbon cloth.

Under such conditions, the anode side is a dead end. Therefore, moisture evaporation from the anode side is inhibited. Furthermore, because the air humidity at the cathode side is 100% RH, a state is assumed in which moisture evaporation from the cathode side is small. Thus, under these conditions, moisture movement to the outside of the cell is inhibited. Therefore, flooding in the cathode catalyst layer easily occurs. Moreover, flooding in the catalyst layer easily occurs at a high current density because the sweep rate of electric current value during measurements is small, the power generation time during measurements is accordingly long, and a large amount of water is generated. Where cell power generation characteristics obtained with the MEA of Example 1 and Comparative Example 1 under such conditions that easily cause flooding are compared, the difference in physical diffusion ability between the cathode catalyst layers in each MEA becomes significant and is reflected in the power generation characteristic. Therefore, the effect of hydrophobizing agent outflow on the power generation characteristic is easily determined.

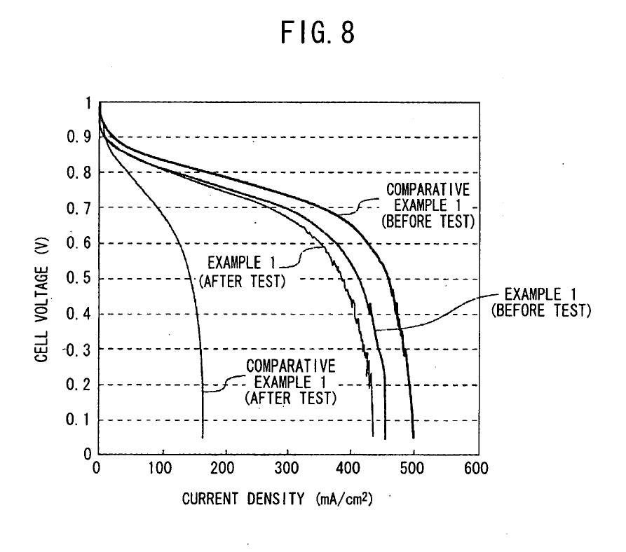

FIG. 8 shows the results relating to a voltage—current density characteristic of each cell. Although the current density prior to the test in Example 1 was 433 mA/cm² and was less than that in Comparative Example 1 (475 mA/cm²), the current density in Example 1 after the test was 407 mA/cm² and larger than that in Comparative Example 1 (157 mA/cm²).

This is supposedly because in the MEA of Example 1, most of the hydrophobizing agent remains even after the test and, therefore, a sufficient amount of the hydrophobizing agent of the catalyst layer is retained. In the MEA of Comparative Example 1, ⅔ of the hydrophobizing agent flowed out due to the immersion test. This is supposedly why the hydrophobicity of the catalyst layer decreased and flooding easily occurred.

Comparing the difference in the current density at 0.4 V between the states before and after the test, in the MEA of Comparative Example 1, the difference was 318 mA/cm², whereas in the MEA of Example 1, the difference was 26 mA/cm² and, therefore, the deterioration of power generation characteristic caused by the immersion test was greatly inhibited.

The results relating to the MEA of Example 1 and the MEA of Comparative Example 1 shown in Table 1 and FIG. 8 demonstrated a high correlation between the Si amount retention ratio and deterioration of cell power generation characteristic. Thus, the hydrophobizing agent outflow prevention effect was found to be directly linked to the improvement of deterioration of cell power generation characteristic.

### Example 3

A MEA was fabricated in the same manner as in Example 1, except that the contact time with the MPTMS vapor in Process 4 of Example 1 was changed to 5 min. The SH group: Au molar ratio was 0.22. The amount of Pt supported on the cathode catalyst layer was 0.6 mg/cm². The Si/Pt molar ratio was 0.23.

### Example 4

A MEA was fabricated in the same manner as in Example 1, except that the contact time with the MPTMS vapor in Process 4 of Example 1 was changed to 7 min. The SH group: Au molar ratio was 1.9. The amount of Pt supported on the cathode catalyst layer was 0.6 mg/cm². The Si/Pt molar ratio was 0.24.

### Example 5

A MEA was fabricated in the same manner as in Example 1, except that the contact time with the MPTMS vapor in Process 4 of Example 1 was changed to 15 min. The SH group: Au molar ratio was 3.1. The amount of Pt supported on the cathode catalyst layer was 0.6 mg/cm². The Si/Pt molar ratio was 0.24.

### Comparative Example 2

A MEA was fabricated in the same manner as in Example 1, except that there was no contact with the MPTMS vapor in Process 4 of Example 1. The SH group: Au molar ratio was 0. The amount of Pt supported on the cathode catalyst layer was 0.6 mg/cm². The Si/Pt molar ratio was 0.12.

### Evaluation of Examples 3 to 5 and Comparative Example 2

The amount of Si in the MEA of Examples 3 to 5 and Comparative Example 2 was analyzed by XRF, and the amount of Si that is a constituent element of the hydrophobizing agent was measured. Then, the MEA were immersed and held for 4 days in warm water at a temperature of 50° C., and the MEA were then dried. The amount of Si was then again measured by XRF. The retention ratio of the amount of Si before and after the test is shown together with a SH/Au amount in Table 2. As follows from Table 2, in the MEA of Comparative Example 2, the Si retention ratio became ⅓, whereas in the MEA of Examples 1 and 3 to 5 in which the SH/Au ratio was 0.2-3.1, the Si retention ration was much higher. The Si retention ratio was particularly high with the SH/Au ratio within a range of 1.9 to 3.1, and the outflow of the hydrophobizing agent could be greatly inhibited.

TABLE 2

| | (Number of Au | | |
|---|---|---|---|
| | atoms)/(Number | (Number of SH | Si retention |
| | of Pt atoms + | moles)/ | ratio after |
| | Number of Au | (Number of Au | deterioration |
| | atoms) × 100 (%) | moles) | test (wt. %) |
| Comparative | 1 | 0 | 33 |
| Example 2 | | | |
| Example 3 | 1 | 0.2 | 62 |
| Example 4 | 1 | 1.9 | 78 |
| Example 1 | 1 | 2.4 | 94 |
| Example 5 | 1 | 3.1 | 87 |

### Example 6

A MEA was fabricated in the same manner as in Example 2, except that the hydrogen reduction treatment of Process 3 in Example 2 was carried out after Process 4. The SH/Au molar ratio was 2.4. The amount of Pt supported on the cathode catalyst layer was 0.6 mg/cm². The Si/Pt molar ratio was 0.12.

### Evaluation of Example 6

The amount of Si in the MEA of Example 6 was analyzed by XRF. Then, a test was carried out in which the MEA was immersed and held for 4 days in a warm water at a temperature of 50° C. The MEA was then dried and the amount of Si was then again measured by XRF. The retention ratio of the amount of Si before and after the test is shown in Table 3. As follows from Table 3, in the MEA of Example 6, the Si retention ration was greatly increased.

TABLE 3

| | (Number of Au atoms)/ | |
|---|---|---|
| | (Number of Pt atoms + | Si retention ratio |
| | Number of Au atoms) × | after deterioration |
| | 100 (%) | test (wt. %) |
| Example 6 | 6 | 85 |

### Comparative Example 3

A MEA was fabricated in the same manner as in Example 1, except that the NAFION addition process of Process 5 in Example 1 was carried out before Process 4. The SH/Au molar ratio was 2.4. The amount of Pt supported on the cathode catalyst layer was 0.6 mg/cm². The Si/Pt molar ratio was 0.12.

### Comparative Example 4

A MEA was fabricated in the same manner as in Example 2, except that the NAFION addition process of Process 5 in Example 2 was carried out before Process 4. The SH/Au molar ratio was 2.4. The amount of Pt supported on the cathode catalyst layer was 0.6 mg/cm². The Si/Pt molar ratio was 0.16.

The catalyst layers were measured by XPS after Process 5 in Comparative Examples 3 and 4. The S2p peak was observed only at 167 eV derived from a sulfonic acid, and no clear peak was observed in the vicinity of 162 eV indicating an Au—S bond. Thus, it was determined that no Au—S thiophene bond was present in the catalyst layer. In Comparative Examples 3 and 4, the formation of the Au—S bond was apparently prevented by the NAFION present between the SH group and Au.

### Evaluation of Comparative Examples 3 and 4

The amount of Si in the MEA of Comparative Examples 3 and 4 was analyzed by XRF. Then, a test was carried out in which the MEA were immersed and held for 4 days in a warm water at a temperature of 50° C. The MEA were then dried and the amount of Si was then again measured by XRF. The retention ratio of the amount of Si before and after the test is shown in Table 4. As follows from Table 4, the MEA of both the Comparative Example 3 and the Comparative Example 4 had a low Si retention ratio, regardless of Au concentration in the catalyst. This result indicates that the NAFION addition process has to be carried out after the MPTMS addition process.

TABLE 4

| | (Number of Au atoms)/ | |
|---|---|---|
| | (Number of Pt atoms + | Si retention ratio |
| | Number of Au atoms) × | after deterioration |
| | 100 (%) | test (wt. %) |
| Comparative | 1 | 38 |
| Example 3 | | |
| Comparative | 6 | 35 |
| Example 4 | | |

### Example 7

In this example, a catalyst layer and a membrane electrode assembly were formed.

### Process I

First, as a catalyst precursor formation process, a PtAuOx layer was deposited to a thickness of 2 μm by a RF reactive sputtering method using Pt (4N) and Au (4N) targets on the surface of a PTFE sheet (NITOFLON™, manufactured by Nitto Denko Corp.; can be referred to hereinbelow as “substrate”). CS-200 by ULVAC Corp. was used as the reactive sputtering apparatus. In this case, the reactive sputtering was carried out under a total pressure of 5 Pa, 100% oxygen gas, and a substrate heater temperature of 40° C. The RF power of each target was adjusted to obtain Au at 1 at. % based on Pt+Au. More specifically, the sputtering was carried conducted under the following conditions: the RF (high frequency of 13.56 MHz) power supplied to the Pt target was 5.4 W/cm² and the RF power supplied to the Au target was 0.27 W/cm².

### Process II

X22-167B (manufactured by Shin-Etsu Silicone Co., mercapto-modified silicone oil, functional group equivalent 1670 g/mol) was used as a hydrophobizing agent, and a solution was prepared by diluting it to 2 wt. % by using IPA as a solvent. The solution was then dropped at a ratio of 18 μl per 1 cm² of the catalyst precursor obtained in Process I, and the appropriate amount of hydrophobizing agent was thereafter formed on the PtAuOx surface by air blowing. The Si/Pt molar ratio in the catalyst precursor was 0.32.

### Process III

The catalyst precursor thus obtained was then reduced by exposing for 30 min to a 2% H₂/He atmosphere, and a PtAu catalyst structural body (B) having a dendritic shape was obtained on the PTFE sheet surface. The supported amount of Pt was 0.6 mg/cm².

### Process IV

A 1 wt. % NAFION solution (a solution obtained by diluting a 5 wt. % NAFION-dispersed solution produced by SIGMA Aldrich Co. with IPA to 1 wt. %) was dropped on the obtained catalyst structural body (B) at a ratio of 8 μl per 1 cm² of the catalyst surface area and the solvent was evaporated under vacuum to form an interface with a proton conductive electrolyte on the catalyst structural body (B) and obtain a catalyst layer.

### Process V

In order to produce an anoode catalyst layer, a platinum-supporting carbon layer was formed on the PTFE sheet surface by a doctor blade method to obtain the supported amount of Pt of 0.3 mg/cm². The catalyst slurry used herein was obtained by kneading 1 part by weight of platinum-supporting carbon (HiSPEC 4000, produced by Johnson Matthey Co.), 0.07 part by weight of NAFION, 1 part by weight of IPA, and 0.4 part by weight of water.

### (Process VI)

A solid polymer electrolyte membrane (NAFION 112, produced by Du Pont Co., thickness 50 μm) was sandwiched between the PTFE sheets having the catalyst layers attached thereto (produced in Process V and VI) so that the catalyst layers were on the inner side, and hot pressing was carried under the following pressing conditions: 4 MPa, 150° C., and 10 min. The PTFE sheets were then removed by peeling off the PTFE sheets from the anode-side and cathode catalyst layers, thereby producing a MEA. Thus, a MEA was obtained in which the cathode catalyst layer was the catalyst layer in accordance with the present invention and the anoode catalyst layer was a platinum-supporting carbon catalyst layer.

### Example 8

A MEA was fabricated in the same manner as in Example 1, except that KF-2001 (manufactured by Shin-Etsu Silicone Co., mercapto-modified silicone oil, functional group equivalent 1900 g/mol) was used as a hydrophobizing agent in Process II of Example 7. The amount of Pt supported on the cathode catalyst layer was 0.6 mg/cm². The Si/Pt molar ratio was 0.24.

### Example 9

A MEA was fabricated in the same manner as in Example 1, except that KF-2004 (manufactured by Shin-Etsu Silicone Co., mercapto-modified silicone oil, functional group equivalent 30,000 g/mol) was used as a hydrophobizing agent in Process II of Example 7. The amount of Pt supported on the cathode catalyst layer was 0.6 mg/cm². The Si/Pt molar ratio was 0.24.

### Evaluation of Examples 7 to 9 and Comparative Example 2

The MEA of Example 7 and Comparative Example 2 were analyzed by X-ray fluorescence analysis (abbreviated hereinbelow as XRF), and the amount of Si that is a constituent element of the hydrophobizing agent was measured. ZSX 1009e (produced by Rigaku KK) was used as the analyzer.

Then, the MEA were immersed and held for 4 days in warm water at a temperature of 50° C. The MEA were thereafter dried by air blowing, and the amount of Si was then again measured by XRF. Because the catalyst layers in the MEA had a history of contact with water for a long time, the outflow amount of the hydrophobizing agent could be measured by comparing the amount of Si in the catalyst layer that was measured before and after the warm water immersion test.

The retention ratio of the amount of Si before and after the test in the MEA of Examples 7 and 8 and Comparative Example 2 is shown in Table 5. The retention ratio of the amount of Si was calculated by dividing the amount of Si after the test in each MEA by the amount of Si before the test.

TABLE 5

| | Si retention ratio after |
|---|---|
| | immersion test (wt. %) |
| Comparative | 33% |
| Example 2 | |
| Example 7 | 99% |
| Example 8 | 70% |
| Example 9 | 64% |

As shown in Table 5, in the MEA of Comparative Example 2, only ⅓ of Si remained after the test, and the outflow of the hydrophobizing agent occurred. By contrast, in Examples 7 to 9, the outflow of the hydrophobizing agent was greatly inhibited.

Fuel cell units were then formed by sandwiching the MEA obtained in Example 7 and Comparative Example 2 between gas diffusion layer 4 (carbon cloth, manufactured by E-TEK Co., LT-2500-W), gas diffusion layer 5 (carbon cloth, manufactured by E-TEK, LT1200-W), anode-side separator 12, cathode-side separator 13, anode-side electrode 6, and cathode-side electrode 7 in the order shown in FIG. 3. The catalyst surface area was 5 cm².

The circumference of the gas diffusion layers 4 and 5 was sealed with an O ring 11. An electronic load device, an air piping, and a hydrogen gas piping were connected to each fuel cell unit and an endurance test of power generation characteristic was carried out. The test was carried out at a cell temperature of 40° C., and a relative humidity of the supplied air and hydrogen gas of 100%. The gas flow rate of hydrogen and air was 50 ccm. As for the power generation conditions, an operation of OCV (Open Circuit Voltage) holding for 10 min after 10 min of power generation at a constant voltage (0.75 V) was repeated as a cycle.

Because, the air humidity on the anode and cathode side under these conditions was 100% RH, a state was assumed in which evaporation of water from the MEA was small. Thus, because motion of moisture to the outside of the cell under these conditions was inhibited, flooding could easily occur in the cathode catalyst layer. Where cell power generation characteristics obtained with the MEA of Example 7 and Comparative Example 5 under such conditions that easily cause flooding are compared, the difference in water-repelling ability between the cathode catalyst layers in each MEA becomes significant and is reflected in the power generation characteristic. Therefore, the effect of hydrophobizing agent outflow on the power generation characteristic is easily determined.

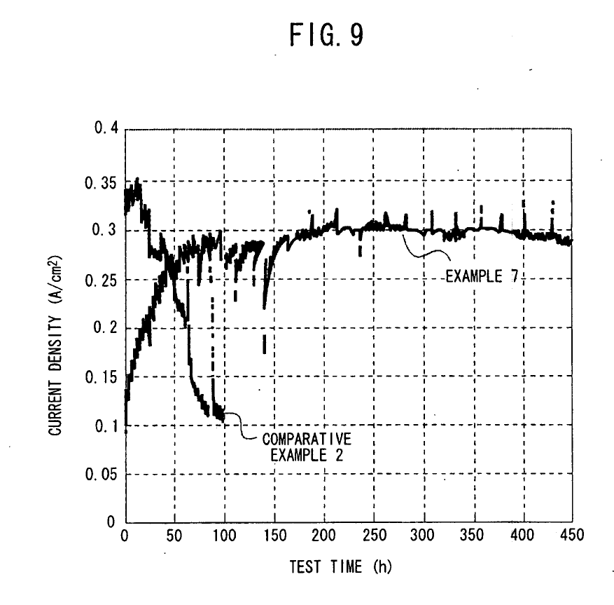

FIG. 9 shows the results relating to variation in current density with time in each fuel cell unit. Although the current density prior to the test in Example 7 was about 73 mA/cm² and was less than that in Comparative Example 2 (320 mA/cm²), the current density increased with the passage of time, and the current density in Example 7 after about 80 h became 280-300 mA/cm², that is, was about the same as the initial current density in Comparative Example 2. In Example 7, the current density became almost constant after 80 h and a stable current density of about 300 mA/cm² could be maintained even after 450 h. By contrast, although the initial current density in Comparative Example 2 was high, the current density decreased with the passage of time and dropped to about 110 mA/cm² after about 95 h. In FIG. 9, there are several points in which the current density increases or decreases. These are apparently the effect of temporary flooding or blow-out of accumulated water and do not represent a stable power generation state. Therefore, they have to be ignored.

The results shown in FIG. 9 suggest that because the outflow of hydrophobizing agent could be greatly inhibited, a sufficient hydrophobicity of the catalyst layer could be maintained. The reason for the current density being low at the initial state of the test and gradually increasing thereafter has not been established, but this is apparently due to optimization of hydrophobizing agent arrangement in the catalyst layer.

In Comparative Example 2, the hydrophobizing agent flowed out with the water produced during power generation. This is supposedly why hydrophobicity of the catalyst layer decreased, flooding has occurred, and current density that could be generated was decreased.

The present invention provides a catalyst layer that has good water resistance and in which outflow of the hydrophobizing agent present on the catalyst layer is prevented, a membrane electrode assembly, a fuel cell, and a method for manufacturing a catalyst layer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-157986, filed Jun. 17, 2008, which is hereby incorporated by reference herein in its entirety.

What is claimed is:

1. A catalyst layer comprising:
a catalyst structural body including platinum and gold, a proton conductive electrolyte, and a siloxane polymer having a hydrophobic group and a group comprising —SH, wherein
a sulfur atom of the group comprising —SH of the siloxane polymer and the gold of the catalyst structural body are bound by a thiol bond.

2. The catalyst layer according to claim 1, wherein a ratio Si/(Pt+Au) of number of atoms of silicon, platinum, and gold in the catalyst layer is 0.1 to 0.32 at. %.

3. The catalyst layer according to claim 1, wherein an amount of gold of the catalyst structural body is 0.1 to 6.4 at. % an amount of gold and platinum of the catalyst structural body.

4. The catalyst layer according to claim 1, wherein the group comprising —SH of the siloxane polymer is any one group from among an alkylthiol, an alkylenethiol, and an alkanethiol having 2 to 8 carbon atoms.

5. The catalyst layer according to claim 1, wherein
the catalyst structural body has a dendritic shape.

6. A membrane electrode assembly comprising the catalyst layer according to claim 1 and a polymer electrolyte membrane.

7. A fuel cell comprising the membrane electrode assembly according to claim 6, a gas diffusion layer, and a current collector.

8. A method for manufacturing a catalyst layer, comprising the processes of:
(1) attaching a Si compound (a) comprising Si, —OH bound to the Si or a group that is bound to the Si and becomes —OH upon hydrolysis, and a hydrophobic group to a surface of a catalyst precursor comprising platinum oxide and gold oxide or gold;
(2) reducing the catalyst precursor to which the Si compound (a) has been attached to obtain a catalyst structural body (A);
(3) attaching a Si compound (b) comprising Si, —OH bound to the Si or a group that is bound to the Si and becomes —OH upon hydrolysis, and a group comprising —SH to a surface of the catalyst structural body (A); and
(4) attaching a proton conductive electrolyte to a surface of the catalyst structural body (A) to which the Si compound (b) has been attached.

9. A method for manufacturing a catalyst layer, comprising the processes of:
(i) forming a siloxane polymer comprising a hydrophobic group and a group comprising —SH on a surface of a catalyst precursor comprising platinum oxide and gold oxide or gold;
(ii) reducing the catalyst precursor on which the siloxane polymer has been attached to obtain a catalyst structural body (B); and
(iii) attaching a proton conductive electrolyte to a surface of the catalyst structural body (B).

10. A method for manufacturing a catalyst layer, comprising the processes of:
(I) forming a siloxane polymer comprising a hydrophobic group and a group comprising —SH on a surface of a catalyst precursor comprising platinum oxide and gold oxide or gold;
(II) attaching a proton conductive electrolyte to the surface of the catalyst precursor on which the siloxane polymer has been formed; and
(III) reducing the catalyst precursor to which the proton conductive electrolyte has been attached.

11. The method for manufacturing a catalyst layer according to claim 9, wherein the process of forming a siloxane polymer comprising a hydrophobic group and a group comprising —SH on a surface of a catalyst precursor comprising platinum oxide and gold oxide or gold comprises the steps of:
(α) attaching a Si compound (a) comprising a hydrophobic group and —OH or a group and becomes —OH upon hydrolysis to a surface of the catalyst precursor; and
(β) attaching a Si compound (b) comprising Si, —OH bound to the Si or a group that is bound to the Si and becomes —OH upon hydrolysis, and a group comprising —SH to the surface of the catalyst precursor to which the Si compound (a) has been attached.
